(19) United States
(12) Patent Application Publication
(10) Pub. No.: US 2013/0295891 A1
(43) Pub. Date: Nov. 7, 2013

(54) METHOD AN APPARATUS OF PROVIDING SERVICE MOBILITY AMONG USER EQUIPMENTS

(71) Applicant: ELECTRONICS AND TELECOMMUNICATIONS RESEARCH INSTITUTE, (US)

(72) Inventors: Hwa Shin MOON, Daejeon-si (KR); Dong Hun LEE, Daejeon-si (KR); Jae Chan SHIM, Daejeon-si (KR); Hwa Suk KIM, Daejeon-si (KR); Kee Seong CHO, Daejeon-si (KR)

(73) Assignee: ELECTRONICS AND TELECOMMUNICATIONS RESEARCH INSTITUTE, Daejeon-si (KR)

(21) Appl. No.: 13/874,694

(22) Filed: May 1, 2013

(30) Foreign Application Priority Data
May 2, 2012 (KR) 10-2012-0046304

(51) Int. Cl. H04W 4/16

(52) U.S. Cl. CPC H04W 4/16
USPC 455/414.1

(57) ABSTRACT

A method and apparatus of providing service mobility among user equipments capable of providing continuity of service context are provided. When a movement request signal for requesting a movement of a first service being executed in the first terminal from the first terminal to a second terminal is received, service data with respect to the first service and a associating service are transmitted to the second terminal.

### CROSS-REFERENCE TO RELATED APPLICATIONS

This application claims the benefit of priority Korean Patent Application No. 10-2012-0046304 filed on May 02, 2012, which is incorporated by reference in its entirety herein.

### BACKGROUND OF THE INVENTION

1. Field of the Invention

The present invention relates to an inter-user equipment service mobility technique and, more particularly, to a method and apparatus of providing service mobility among user equipments to provide continuity of service context when terminals are switched while using a service.

2. Related Art

As mobile terminals are prevalent, interest in N-screen is increasing. N-screen refers to a technique or a service allowing user to continuously enjoy single multimedia contents (movie, music, and the like) through N number of terminals. To this end, providing of service continuity according to switching of terminals (or user equipments) has been studied in various aspects.

Providing continuity (or mobility) according to a change of terminals include two types: providing continuity through a network and providing continuity by services. Providing service continuity through a network means that an entity that controls service continuity exists in a network. In this case, continuity of various services may be provided through the entity. Research of the method has been in progress based on 3GPP (3rd Generation Partnership Project). 3GPP proposes a service continuity support method having a structure in which SCC-AS (Service Centralization and Continuity Application Server) performing a session anchoring operation is included on an IMS(IP Multimedia Subsystem) wired/wireless integrated control platform. In this structure, the SCC-AS exists on every signaling path with respect to an IMS-based service and manages connections between sessions constituting a service. Thus, the SCC-AS can recognize a terminal or network change request and sessions affected by performing a corresponding change, and is able to control changing of the sessions. Service mobility according to changing terminals through a control structure based on such an SCC-AS has been actively discussed in release 9 and release 10, and currently, in release 11 as well. Although 3GPP focuses only on session control for service mobility yet, a concept of managing and providing records or history with respect to a service has been presented in some articles. However, these articles focus only on records or history in relation to a service, rather than proposing a specific method.

Meanwhile, methods of providing continuity by services have been provided/studied based on a particular service such as a multimedia service, a Web service, or the like. In these methods, when a service mobility request is requested and subsequently a service is used in a mobility-target terminal, a user is allowed to view a service continuously starting from an existing VoD (video on demand) view position or use a Web service in the same state as that of an existing Web context, thus providing service continuity. In this method, continuity is provided in consideration of even a continuity aspect of service data or a service environment. However, this method is provided by services, so it is limited to corresponding services.

As described above, supporting service continuity (or mobility) according to change of terminals is based on a movement with respect to some data such as a connection establishment control and service usage state therefor. However, the service usage state has shortcomings in that it is limited only to a service itself. For example, making of a conference record file during a service such as a video conference or memo regarding important information using an office program is a product produced in relation to a video conference service, so it may be appropriate to be included in a service usage environment in user aspects, but not available in the current technique.

### SUMMARY OF THE INVENTION

The present invention provides a method and apparatus for providing service mobility between user equipments capable of providing a continuous service environment between a previous terminal (or a previous user equipment) and a switched new terminal (or a changed new user equipment) when the previous terminal, which has received a service, is switched to the new terminal.

In an aspect, a method of providing service mobility among user equipments to provide continuity of service context, performed by a service continuity control server, is provided. The method includes: receiving continuity support service information from a first terminal; receiving a movement request signal for requesting a movement of a first service being executed in the first terminal from the first terminal to a second terminal; and transmitting service data with respect to the first service and second service to the second terminal, wherein the continuity support service information includes information regarding correlation between the first and second services, and the second service is a service which was executed in the first terminal in relation to the first service.

The first service may be a network service provided through a network, and the second service may be a different network service provided from the first terminal through a network or a service independently provided in the first terminal.

The continuity support service information may further include service history metadata and actual service data, wherein the service history metadata includes metadata for constituting a first service and a second service and the actual service data includes information regarding identifiers (IDs) and outcome of the first service and the second service.

The method may further include: updating information regarding a service data distribution state indicating a service data distribution state with respect to the first terminal and the second terminal.

In another aspect, a method of providing service mobility performed by a terminal is provided. The method includes: obtaining information regarding a participant of a first network service being executed in a terminal; determining whether or not the participant of the first network service is participating a second network service; when the participant of the first network service is participating the second network service, generating information regarding correlation indicating an association between the first network service and the second network service; determining whether or not there is a local service connected to the first network service; and storing service data with respect to the second network service associated with the first network service and the local service.

The method may further include: obtaining information regarding an association with respect to the network-based service ongoing in the terminal when the local service starts to be provided, in order to determine whether or not there is a local service connected to the first network service.

The method may further include: transmitting a movement request signal for requesting a movement to a different terminal, to a service continuity control server; and transmitting the correlation information and the service data to the service continuity control server.

In another aspect, a service continuity control server providing continuity of service context is provided. The service continuity control server includes: a service movement controller configured to receive a movement request signal for requesting a movement of a first service being executed in a first terminal from the first terminal to a second terminal; and a service data continuity controller configured to receive continuity support service information from the first terminal and transmitting service data with respect to the first service and second service to the second terminal, wherein the continuity support service information includes information regarding correlation between the first service and the second service, and the second service is a service which was executed in the first terminal in relation to the first service.

The first service may be a network service provided through a network, and the second service may be a different network service provided from the first terminal through a network or a service independently provided in the first terminal.

The continuity support service information may further include service history metadata and actual service data, the service history metadata includes metadata for constituting a first service and a second service, and the actual service data may include information regarding identifiers (IDs) and outcome of the first service and the second service.

When a service terminal is changed from the first terminal to the second terminal, the service data continuity controller may update information regarding a service data distribution state indicating a service data distribution state with respect to the first terminal and the second terminal.

In another aspect, a terminal is provided. The terminal includes: a service state management module configured to obtain information regarding a participant of a first network service being executed in the terminal, determine whether or not the participant of the first network service is participating in a second network service being executed in the terminal to generate information regarding correlation between the first network service and the second network service, and determine whether or not there is a local service connected to the first network service to generate information regarding correlation between the first network service and the local service; and a service data management module configured to store service data with respect to the first network service and service data with respect to the second network service associated with the first network service and the local service.

The terminal may further include: a service movement providing module configured to transmit a movement request signal for requesting a movement to a different terminal, to the service continuity control server, and transmit the service data with respect to the first network service and the service data with respect to the local service to the service continuity control server.

### BRIEF DESCRIPTION OF THE DRAWINGS

FIG. 1 is a conceptual view illustrating a situation to which the present is applicable and a method for providing continuity when service is moved between terminals according to an embodiment of the present invention.

FIG. 2 is a block diagram showing a configuration of a system for providing service continuity.

FIG. 3 is a view illustrating an example of ‘continuity support service information’ managed by a service data management module (client) of a terminal.

FIGS. 4 and 5 are flow charts illustrating an example of a method of obtaining/managing correlation between services in order to define service data in view of a user by a service state management module existing in a terminal, respectively.

FIG. 6 is a flow chart illustrating an operation of a service data movement control module of a service data continuity controller.

FIG. 7 is a flow chart illustrating a method for improving a problem related to (1) to be considered when a service data size mentioned in FIG. 6 is large.

FIG. 8 is a flow chart illustrating a method of providing the latest data with respect to a service to a user when the latest data exists when the service starts to be provided.

FIG. 9 is a flow chart illustrating an operation of managing service data distributed in each terminal by the service continuity control server when a service is terminated.

### DESCRIPTION OF EXEMPLARY EMBODIMENTS

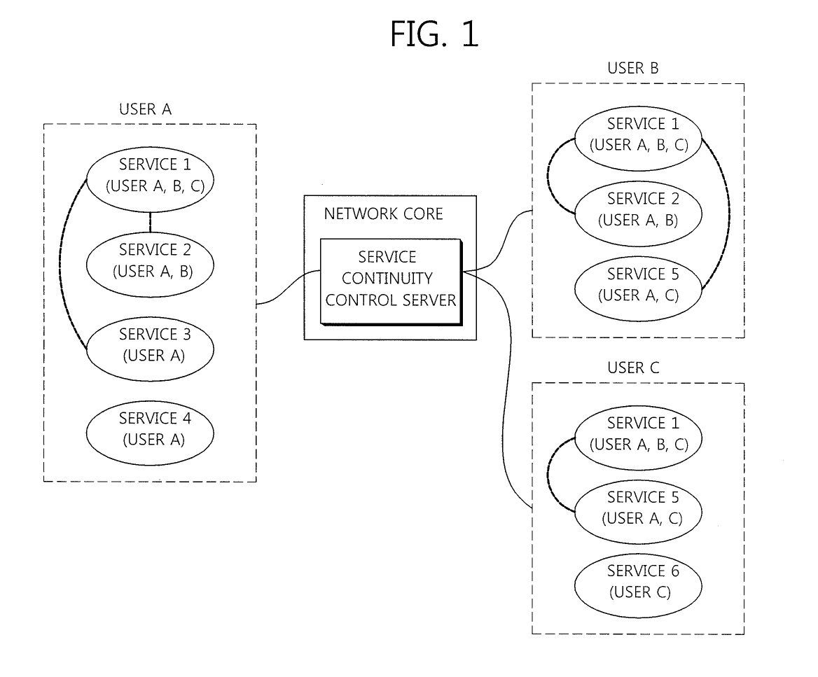

FIG. 1 is a conceptual view illustrating a situation to which the present is applicable and a method for providing continuity when service is moved between terminals according to an embodiment of the present invention.

Referring to FIG. 1, user A, user B, and user C use service 1 together. Service 1 may be, for example, a video conference.

User A, who is using service 1, may temporarily opens a different video conference service (referred to as ‘service 2’, hereinafter) in order to discuss a different issue with user B and subsequently terminate it. Also, the user A is using a local program (e.g., service 3) independently operating only in the corresponding terminal, such as a memo pad, in order to take notes a portion of conference content during the video conference (service 1). Besides, the user A may use an extra service (service 4) in the terminal. Service 4 may be a local program or a service through a network.

The user B may also open a chatting service (referred to as ‘service 5’, hereinafter) and use it to discuss an extra issue with user C, besides service 1. Service 2 was terminated after having been opened temporarily for a video conference with the user A. The user C may also use service 1, service 5, and service 6 as a local program.

In this case, it is assumed that the user A determines to change a terminal that receives a service (e.g., he changes from a tablet PC to a smart phone). Existing methods for service continuity are focused on a movement of data of service 1 (i.e., a service through a network) to the changed new terminal.

However, in the case of the user A, he or she may want to check information used in the service 2 which was already terminated, while using the service 1. Also, he may want to keep taking notes of an issue or subject created in the previous terminal with the changed new terminal by using a local program such as an office program, or the like. Namely, the user A may want to continuously use the service 3 which is locally ongoing.

In other words, when the terminal which has executed the service (service 1) through a network is switched to a different terminal, the user A may also want to move data of the different service (the service 2 and service 3 in the above example) associated with the service through a network.

To this end, a service continuity providing method for checking an association between services in moving a service between terminals and considering all the associated service data is required.

Hereinafter, service types are classified into a network service and a local service and described. Here, a network service refers to a service, such as a Web service, a video call, or the like, which is used through a network. A local service refers to a program, such as a word processor, a paint board, or the like, independently operated in a terminal.

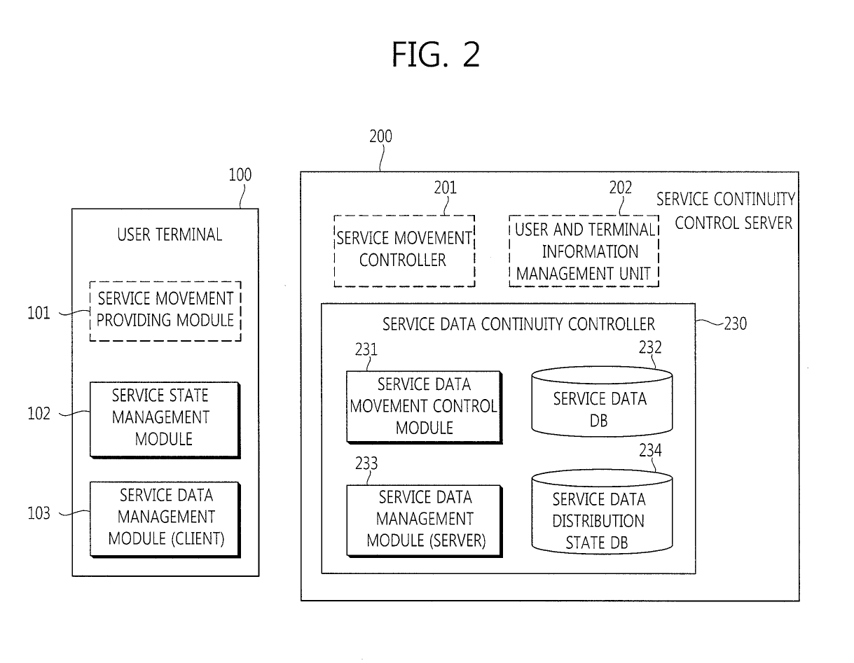

FIG. 2 is a block diagram showing a configuration of a system for providing service continuity.

Referring to FIG. 2, a user terminal 100 (referred to as a ‘terminal’, hereinafter) may include a service state management module 102 and a service data management module (client) 103, in addition to an existing service movement providing module 101 providing a service movement function.

The service state management module 102 existing in the terminal 100 is a module that defines/manages correlation between respective services ongoing in a corresponding terminal to provide service continuity. The service state management module 102 generates correlation information defining correlation between services. For example, correlation information may indicate that a first network service and a second network service executed in a terminal are associated or that the first network service and a local service are associated. The associated services based on the correlation information are called continuity support services.

The service data management module (client) 103 of the terminal 100 is a module connected to a service data management module (server) 233 of a server to manage service data with respect to services, namely, continuity support services, having correlation defined by the service state management module 102. Here, the service data with respect to the continuity support services may include metadata or actual service data.

Hereinafter, the foregoing correlation information, the metadata with respect to continuity support services, or actual service data will be referred to as continuity support service information.

The terminal 100 may further include the service movement providing module 101. The service movement providing module 101 may transmit a movement request signal for requesting a movement to a different terminal, to the service continuity control server 200, and transmit continuity support service information to the service continuity control server 200.

The service continuity control server 200 may include a service movement controller 201, a user and terminal information management unit 202, and a service data continuity controller 230.

The service movement controller 201 may manage a service movement with respect to the terminal and receive a movement request signal for requesting a movement from a first terminal to a second terminal. The user and terminal information management unit 202 manages a terminal ID (identity), user information, or the like. As the service movement controller 201 and the user and terminal information management unit 202, conventional modules may be used.

The service data continuity controller 230 includes a service data movement control module 231, a service data management module(server) 233, a service data DB 232, and a service data distribution state DB 234 managing a service data distribution state. The service data continuity controller 230 may receive continuity support service information from the first terminal, and when a terminal switch from the first terminal to the second terminal is requested, the service data continuity controller 230 may transmit service data based on the continuity support service information.

The service data DB 232 stores/manages continuity support service information managed by each terminal. The service data distribution state DB 234 manages a list of terminals in which the continuity support service has been used. The service data distribution state DB 234 may be updated after the continuity support service is terminated.

The service data management module (server) 233 may perform an operation of managing the foregoing service data DB 232 and the service data distribution state DB 234 and continuity support service information managed by each terminal by interworking with the service data management module (client) 103.

The service data movement control module 231 performs an operation related to a movement of service data with respect to a continuity support service managed by the terminal 100 and the service continuity control server 200 to a corresponding terminal when a terminal is changed during the continuity support service.

The forgoing service data continuity controller 230 may be additionally implemented within the existing service continuity control server or may exist separately to interwork with an existing inter-terminal service movement system.

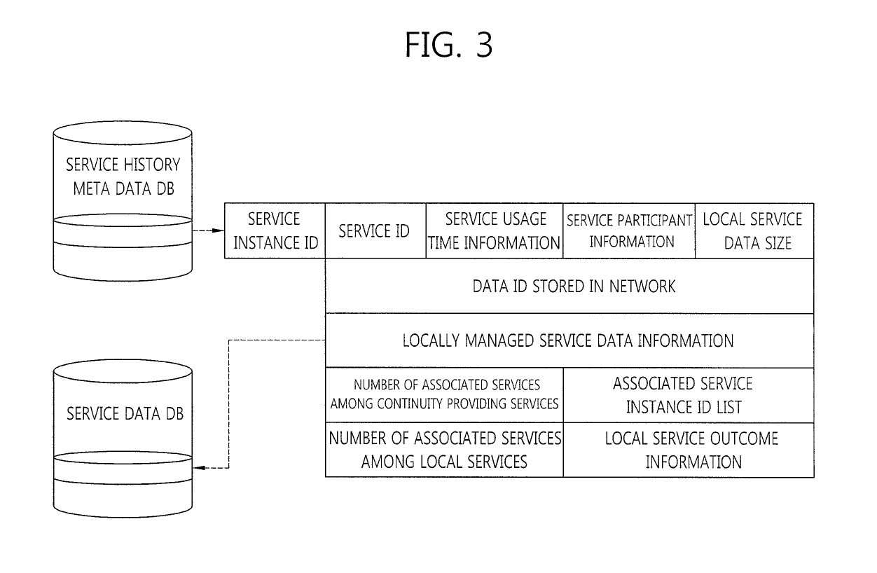

FIG. 3 is a view illustrating an example of ‘continuity support service information’ managed by the service data management module (client) of the terminal. Referring to FIG. 3, the service data management module (client) 103 discriminately manage metadata (this is also called service history metadata) with respect to service data and service data generated during an actual service. Namely, the ‘continuity support service information’ includes service history metadata and actual service data. Also, the ‘continuity support service information’ may include information regarding correlation between a network service and a local service.

The service history metadata among the continuity support service information has corresponding service information (service ID) of each service instance being executed, service usage time information (start time, whether service has been terminated, a termination time when terminated), service participant information, and size information of total service data (data size of local service) managed by the terminal as well.

Also, the continuity support service information has information required for configuring actual service data. First information is ID information (data ID stored in a network) with respect to service data stored in the service continuity control server. In general, in case of a service such as chatting, or the like, among network services, exchanged messages may be stored in a network. In this case, only ID information by which the message can be searched is retained in the metadata, rather than being separately stored locally.

Second information is locally stored data (locally managed service data information) during a service. For example, when a file is transmitted/received during chatting, there may be a case in which data cannot be stored in a network according to a transmission/reception method. Such data is managed by the service data DB of the terminal and the metadata retains corresponding position information. Here, the service data DB retains a state of data (i.e., in case of a file whether or not the file is open), as well as corresponding data.

The continuity support service information includes correlation information. The correlation information may include information regarding a network service having correlation with respect to a particular service. For example, the correlation information may include the number of services having correlation among network services, and a service instance ID list. Namely, the continuity support service information may include a network service associated with a continuity support service, and a list of metadata information with respect to an associated network service.

Also, the correlation information may include information regarding a local service having correlation with respect to a particular service. For example, the correlation information may include the number of services having correlation among local services and a list of local service output information. For example, in case of a local service to which a paint board and memo pad program is associated, each local service outcome information may be position information of a result file, i.e., a paint and txt file, of the last version along with whether or not program is performed/terminated. These information may be stored in a hard disk of the terminal. The local service outcome may be managed by the changed new terminal or a service data DB of the continuity control server as necessary. The service data management module of the continuity control server has a similar form, except that a DB for managing data stored in a network exists additionally. As described above, the service data management module manages service data in the pre-movement/post-movement terminal and performs a restoration operation based on service data at a movement timing. Here, during the restoration operation, data managed in a network is received and used for configuring a service environment, but is not required to be stored in the terminal separately.

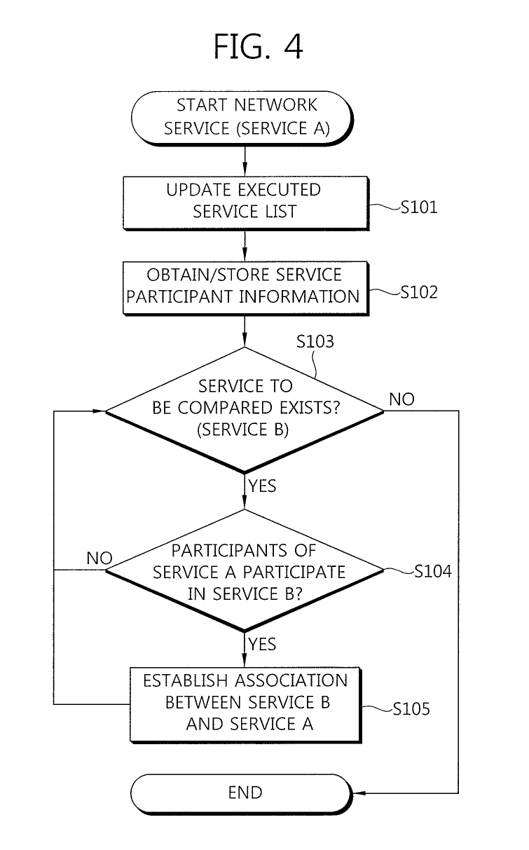

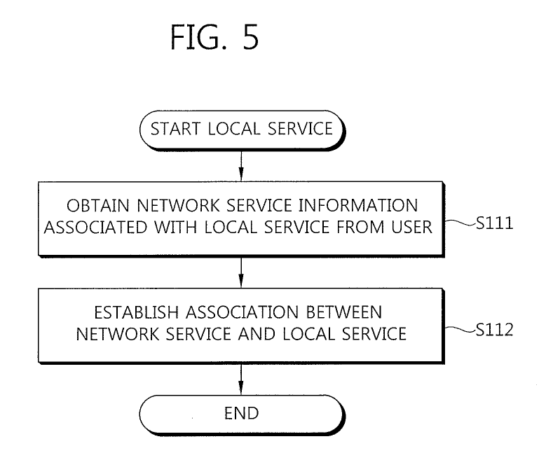

FIGS. 4 and 5 are flow charts illustrating an example of defining correlation information among continuity support service information in view of a user by a service state management module existing in a terminal, respectively.

Referring to FIG. 4, when a network service (service A) is executed, the service state management module preferentially updates a list of services being executed (S101). Although not shown, when a particular service is terminated, the service state management module 102 also updates a list of services being executed.

The service state management module 102 obtains information regarding a participant participating in a network service and stores the same (S102). In case of some Web services, there may not be a participant, and there may be one participant like a video call or there may be several participants like a video conference.

The service state management module 102 determines whether or not there is a service to be compared with respect to the network service (service A) being executed (S103). The service to be compared refers to other network services that may be connected to the network service and are being currently executed. It is assumed that the service to be compared is a service B. In this case, the service state management module 102 determines whether or not participants of the service A are participating in the service B (S1040. When the participants of the service A are participating in the service B, the service state management module 102 establishes association between the service A and the service B (S105). Namely, correlation is established between the service A and the service B, and the service state management module 102 generates correlation information indicating such a relationship.

IDs identifying respective participants of each service may be different, so the service state management module 102 may manage an address list for managing the IDs of particular people for respective services.

Referring to FIG. 5, when a local service starts, the service state management module 102 may display a list of network services ongoing currently for a user, and receive network service information associated with a local service from the user (S111). Namely, in order to determine whether or not there is a local service connected to the network service, association information with respect to the network-based service ongoing in the terminal may be obtained when a local service starts. The service state management module 102 establishes association between the local service and the network service based on the information input by the user (S112).

Namely, the service state management module 102 performs a function of obtaining information regarding a participant of the network service, determining whether or not there is a local service connected to the network service, and determining whether or not the participant of the network service is participating in a different network service. Also, when there is a different network service including the participant of the network service, the service state management module 102 establishes an association between the two network services and generates correlation information. Data with respect to continuity support services indicated by the correlation information may be stored/managed by the service data management module 103.

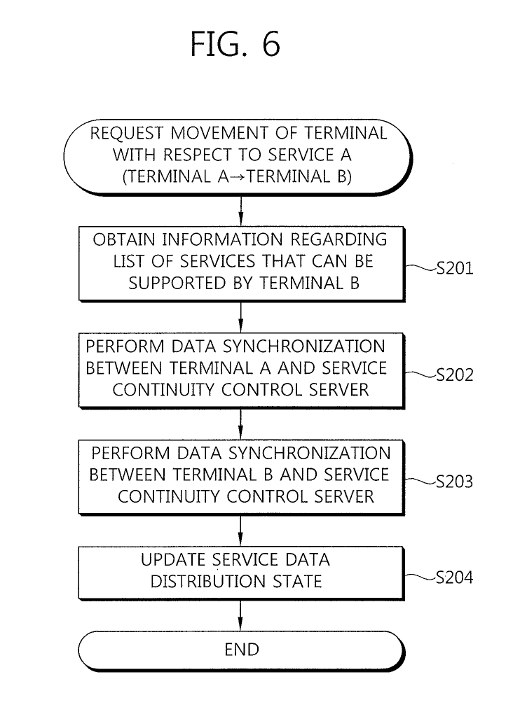

FIG. 6 is a flow chart illustrating an operation of a service data movement control module of a service data continuity controller.

For example, it is assumed that the user requests a service movement from a terminal a to a terminal b with respect to the service A. In this case, the service data management module 233 obtains information regarding a list of services that can be supported by the terminal b (S201). This process may be expressed by obtaining capability information such as a list of services that can be supported with respect to each terminal of the user by the service data management module 233.

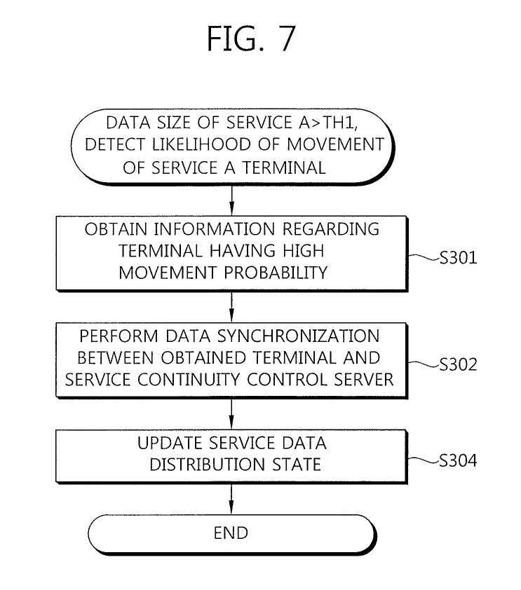

Based on the supportable service list information, the service data management module 233 performs an operation of classifying supported data and unsupported data among data with respect to the current service A and data of services associated with the service A. The service data management module 233 performs service data synchronization between the existing terminal and the continuity control server 200 (S202). Here, the data synchronization is performed differently according to a data size and a supportable service list. In case of moving data through a network, if the data size is large, a movement time is increased. In this case, there is inconvenience (1) in that a time required for a movement target terminal to use service data is lengthened, and inconvenience (2) in that when the user wants to terminate the existing terminal, a termination standby time is also lengthened. Among them, an improvement in relation to (1) will be described later with reference to FIG. 7. In an embodiment of the present invention, in order to avoid the inconvenience (2), when a size of data locally managed by the service data management module is equal to or greater than a certain value TH1, corresponding data are periodically uploaded to the service continuity control server 200. When a size of service data is large, data synchronization between the existing terminal and the control server is performed such that actually every service data is uploaded to the service continuity control server 200.

When a size of data is small, a synchronization method is determined according to the supportable service list. If every existing data is supported in the movement target terminal, synchronization may be performed only in the view of the service history metadata. Meanwhile, when some data is not supported, the unsupported data is uploaded to the service continuity control server 200, and the service continuity control server 200 corrects the service history metadata in this relation and manages the same. Namely, the synchronization expressed in an embodiment of the present invention may mean that it is an operation for making the latest interpretable state, rather than indicating perfect consistency of data.

When the synchronization operation with the existing terminal (terminal a) is completed, synchronization operation with the movement target terminal (terminal b) is performed (S203). The synchronization operation with the movement target terminal is also performed according to a service data size and a supportable data range. Namely, when service data is large, the terminal may receive the service data from the service continuity control server 200, and when service data is small, the terminal may receive it from a terminal. Also, the terminal may not receive unsupportable service data. Thereafter, the service data distribution state is updated. Namely, updating is performed such that the terminal b as well as the terminal a has the history with respect to the corresponding service in a service data distribution table.

FIG. 7 is a flow chart illustrating a method for improving a problem related to (1) to be considered when a service data size mentioned in FIG. 6 is large.

Referring to FIG. 7, when a data size of a service is equal to or greater than a certain size, the service data movement control module detects whether or not the service can be moved between terminals. The service data movement control module obtains information regarding a terminal having a high movement probability (S301). Information in this connection may be obtained by using a technique proposed in Korean Patent Application No. 2010-0091026, entitled “Apparatus and method for determining mobile terminal”, Applicant: Electronics and Telecommunications Research Institute) or through an interworking operation with a service mobile terminal determining server proposed this patent application. When information regarding a terminal having high movement probability is obtained, the service data movement control module performs a data synchronization operation on each terminal (S302). Such data synchronization may be periodically performed. The service data movement control module performs updating by reflecting information indicating that the service data information has been transmitted to the corresponding terminals for the foregoing reason in the service data distribution state (S303).

The service data management module exists in the server and the terminal to thereby perform an operation of managing service data. Basically, as described above, the service data management module performs an operation of logically synchronizing the service data (service data alone and service data including metadata). Also, when a data size is large, the service data management module performs synchronization and metadata management on the entire data, and thereafter, performs a periodical synchronization operation. Also, the service data management module supports the user to perform an operation such as searching for service data, deleting service data, or the like.

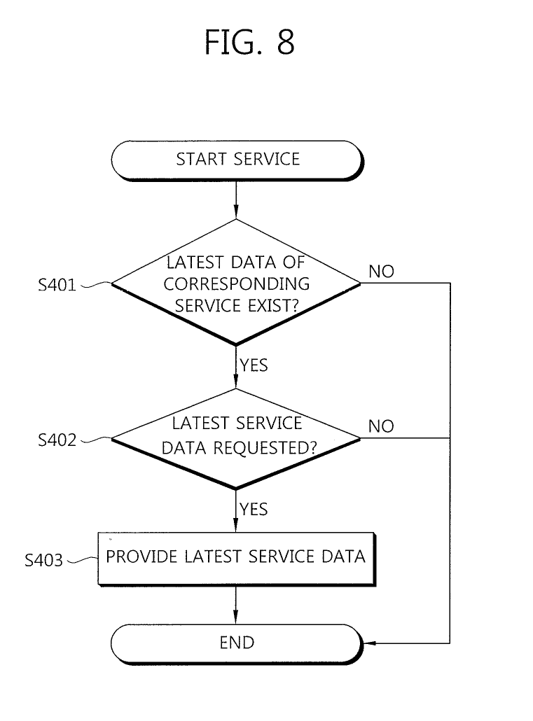

FIG. 8 is a flow chart illustrating a method of providing the latest data with respect to a service to a user when the latest data exists when the service starts to be provided.

Referring to FIG. 8, the service continuity control server determines whether or not there is the latest service data with respect to a corresponding service (S401). When there is the latest service data with respect to the corresponding service, the service continuity control server determines whether or not there is a request for the latest service data (S402). When there is a request for the latest service data, the service continuity control server provides the latest service data (S403).

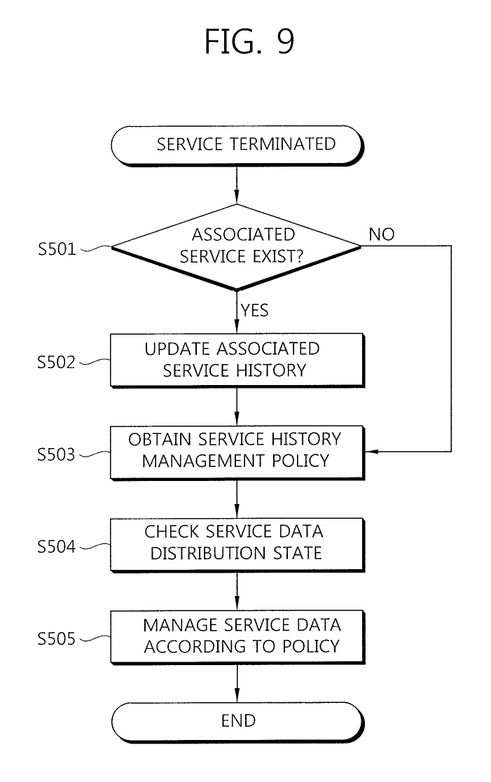

FIG. 9 is a flow chart illustrating an operation of managing service data distributed in each terminal by the service continuity control server when a service is terminated.

Referring to FIG. 9, when a service is terminated, the service continuity control server checks whether or not there is a service associated with the terminated service (S501). Here, the associated service may be a service associated with the terminated service based on correlation information. When an associated service exists, the service continuity control server performs updating by reflecting the terminated service data in associated service history (S502). Thereafter, the service continuity control server obtains user's service history management policy with respect to the service data (S503). In this case, a pre-set value may be used or the policy may be directly obtained from the user. The service history management policy may be, for example, an operation of deleting all the service data or keeping the service data in only the control server and deleting it from the terminal, or the like, when the service is terminated.

Thereafter, the service data management module checks a service data distribution state (S504) and manages service data according to the service history management policy (S505). In this case, it may happen that service data should be deleted according to the service history management policy, but it is not deleted because the corresponding terminal has been terminated. In this case, the service data is additionally managed, and whenever the terminal is connected, whether to delete the service data may be checked and a corresponding operation may be performed.

When the user switches a terminal using particular services, data included in different services driven under the necessity among the particular services, as well as data included in the particular services, are moved to the changed new terminal from a previous terminal, thereby providing continuity of a service environment. Thus, when a terminal is switched during a service, users can conveniently use the service in the changed new terminal.

While the present invention has been shown and described in connection with the embodiments, it will be apparent to those skilled in the art that modifications and variations can be made without departing from the spirit and scope of the invention as defined by the appended claims.

What is claimed is:

1. A method of providing service mobility among user equipments to provide continuity of service context, performed by a service continuity control server, the method comprising:
receiving continuity support service information from a first terminal;
receiving a movement request signal for requesting a movement of a first service being executed in the first terminal from the first terminal to a second terminal; and
transmitting service data with respect to the first service and second service to the second terminal,
wherein the continuity support service information includes information regarding correlation between the first and second services, and the second service is a service which was executed in the first terminal in relation to the first service.

2. The method of claim 1, wherein the first service is a network service provided through a network, and the second service is a different network service provided from the first terminal through a network or a service independently provided in the first terminal.

3. The method of claim 1, wherein the continuity support service information further includes service history metadata and actual service data, the service history metadata includes metadata for constituting the first service and the second service, and the actual service data includes information regarding identifiers (IDs) and outcome of the first service and the second service.

4. The method of claim 1, further comprising:
updating information regarding a service data distribution state indicating a service data distribution state with respect to the first terminal and the second terminal.

5. A method for providing service mobility performed by a terminal, the method comprising:
obtaining information regarding a participant of a first network service being executed in a terminal;
determining whether or not the participant of the first network service is participating a second network service;
generating correlation information indicating an association between the first network service and the second network service when the participant of the first network service is participating the second network service;
determining whether or not there is a local service associated with the first network service; and
storing service data with respect to the second network service and the local service associated with the first network service.

6. The method of claim 5, further comprising:
obtaining information regarding an association between a network-based service, to be executed in the terminal, and the local service when the local service beginsin the terminal.

7. The method of claim 5, further comprising:
transmitting a movement request signal for requesting a movement to a different terminal, to a service continuity control server; and
transmitting the correlation information and the service data to the service continuity control server.

8. A service continuity control server providing continuity of service context, the server comprising:
a service movement controller configured to receive a movement request signal for requesting a movement of a first service being executed in a first terminal from the first terminal to a second terminal; and
a service data continuity controller configured to receive continuity support service information from the first terminal and transmitting service data with respect to the first service and second service to the second terminal,
wherein the continuity support service information includes information regarding correlation between the first service and the second service, and the second service is a service which was executed in the first terminal in relation to the first service.

9. The server of claim 8, wherein the first service is a network service provided through a network, and the second service is a different network service provided from the first terminal through a network or a service independently provided in the first terminal.

10. The server of claim 8, wherein the continuity support service information further includes service history metadata and actual service data, wherein the service history metadata includes metadata for constituting a first service and a second service and the actual service data includes information regarding identifiers (IDs) and outcome of the first service and the second service.

11. The server of claim 8, wherein when a service terminal is changed from the first terminal to the second terminal, the service data continuity controller updates information regarding a service data distribution state indicating a service data distribution state with respect to the first terminal and the second terminal.

12. A terminal comprising:
a service state management module configured to obtain information regarding a participant of a first network service being executed in the terminal, determine whether or not the participant of the first network service is participating in a second network service being executed in the terminal to generate correlation information between the first network service and the second network service, and determine whether or not there is a local service connected to the first network service to generate correlation information between the first network service and the local service; and
a service data management module configured to store service data with respect to the first network service and service data with respect to the second network service associated with the first network service and the local service.

13. The terminal of claim 12, further comprising:
a service movement providing module configured to transmit a movement request signal for requesting a movement to a different terminal, to the service continuity control server, and transmit the service data with respect to the first network service and the service data with respect to the local service to the service continuity control server.
